(19) United States
(12) Patent Application Publication
(10) Pub. No.: US 2022/0150713 A1
(43) Pub. Date: May 12, 2022

(54) DYNAMIC SPECTRUM SHARING RESOURCE COORDINATION FOR FIFTH GENERATION WIRELESS COMMUNICATIONS AND BEYOND

(71) Applicant: AT&T Intellectual Property I, L.P., Atlanta, GA (US)

(72) Inventors: Yu Zhou, Somerset, NJ (US); Rittwik Jana, Montville, NJ (US)

(21) Appl. No.: 17/091,534

(22) Filed: Nov. 6, 2020

(51) Int. Cl. H04W 16/14; H04W 72/04; H04W 72/12; H04W 16/10; H04W 24/10

(52) U.S. Cl. CPC H04W 16/14; H04W 72/0426; H04W 72/0433; H04W 24/10; H04W 72/1263; H04W 16/10; H04W 72/0453

(57) ABSTRACT

The disclosed technology is directed towards dynamic spread spectrum (DSS) deployments, in which two cells such as an LTE cell and a new radio (NR) cell share available physical resource blocks. In one implementation, the LTE cell and NR cell each periodically report spectral efficiency data and pending packet data to a controller, such as a RAN intelligent controller, or RIC. The controller uses the reported data, possibly along with biasing weight data, to allocate the total number of available shared spectrum resource blocks to the LTE and NR cells, for use in scheduling their respective user equipment communications until the next reporting period. The resource blocks allocated to the LTE cell do not collide with the resource blocks allocated to the NR cell, such as by top-down, bottom-up frequency division, or via an allocation bitmap sent to each cell.

### TECHNICAL FIELD

The subject application relates to wireless communications systems in general, and more particularly to New Radio (NR) including fifth generation (5G) cellular wireless communications systems and/or other next generation networks, in which dynamic spectrum sharing (DSS) (also referred to as Long Term Evolution (LTE) LTE-NR coexistence, or LNC), allows for deployment in overlapping spectrum.

### BACKGROUND

Fourth Generation Long Term Evolution (4G LTE) and Fifth Generation/New Radio (5G/NR) can be deployed in shared (partially or fully overlapping) spectrum. Dynamic spectrum sharing refers to dynamically allocating resource blocks in time and frequency domains for LTE and NR cells based on the current LTE and 5G traffic. Dynamic spectrum sharing helps mobile operators quickly and cost-effectively roll out 5G services and achieve 5G coverage based on the existing LTE infrastructure, without doing spectrum refarming.

According to the 3rd Generation Partnership Project (3GPP) standard, either the LTE cell site or the 5G cell site can initiate a resource coordination request, which contains a bitmap of 0s and 1s indicating the resource block allocations. When the overall traffic demand from LTE and NR is larger than the spectrum supply, which cell site (LTE or 5G) initiates the resource coordination request, and how resource blocks are to be divided between LTE and NR, can result in completely different network performance for LTE users and NR users.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system configured for dynamic spectrum sharing (DSS) showing a radio access network (RAN) controller allocating resources to Fourth Generation Long Term Evolution (4G LTE, or simply LTE) and 5G new radio (NR) cell sites having overlapping spectrum, in accordance with various aspects and embodiments of the subject disclosure.

FIG. 2 is a block diagram showing example components and data flows for determining allocation of spectrum resources to DSS LTE and 5G (NR) cell sites, in accordance with various aspects and embodiments of the subject disclosure.

FIG. 3 is a block diagram showing an example implementation incorporated into a software platform for a RAN Intelligent Controller (RIC) that determines allocation of spectrum resources to LTE and 5G (NR) DSS cell sites, in accordance with various aspects and embodiments of the subject disclosure.

FIG. 4 is an example representation of priority-based resource block allocations over various reporting periods in a spectrum sharing environment, in accordance with various aspects and embodiments of the subject disclosure.

FIG. 5 is a flow diagram representing example operations of a wireless communication controller to determine allocation of resources to two DSS cells, in accordance with various aspects and embodiments of the subject disclosure.

FIG. 6 is a flow diagram representing example operations of a cell site's network equipment to report cell state information in order to receive allocation of resource blocks for scheduling user equipment devices, in accordance with various aspects and embodiments of the subject disclosure.

FIG. 7 illustrates example operations of network equipment in a spectrum sharing environment to allocate resource blocks to an LTE cell site and a new radio cell site based on received respective channel condition data and traffic data, in accordance with various aspects and embodiments of the subject disclosure.

FIG. 8 illustrates example operations of a RAN controller to determine, based on spectral efficiency data, pending packet size data and total resource blocks available in a spectrum sharing environment, allocation of resource blocks to an LTE cell site and a new radio cell site, in accordance with various aspects and embodiments of the subject disclosure.

FIG. 9 illustrates example operations of a cell site device determine and send condition data and traffic data to a RAN controller to receive a resource block allocation for use in scheduling user equipment, in accordance with various aspects and embodiments of the subject disclosure.

FIG. 10 illustrates an example block diagram of an example mobile handset operable to engage in a system architecture that facilitates wireless communications according to one or more embodiments described herein.

FIG. 11 illustrates an example block diagram of an example computer/machine system operable to engage in a system architecture that facilitates wireless communications according to one or more embodiments described herein.

### DETAILED DESCRIPTION

The technology described herein is generally directed towards improving wireless network and user equipment (UE) performance for both 4G-LTE (fourth generation long term evolution) and NR (new radio) cells, with respect to throughput in a dynamic spectrum sharing (DSS) environment. As can be readily appreciated, this can be significant for 5G applications with high data rate and/or low latency requirements running in a 5G spectrum sharing network. Note that the technology is not limited to 4G-LTE and 5G technologies, but can apply to any technologies in which spectrum is shared, including 5G and beyond.

In general, the LTE cell and the 5G cell each individually collects information (e.g., cell statistics including channel condition data and traffic data) related to its connected UEs, and reports the information to a radio access network (RAN) controller, such as a RIC (RAN Intelligent Controller). Based on the information, the radio access network controller allocates shared spectrum resources (e.g., physical resource blocks) to the LTE cell and the 5G cell. The LTE cell and the 5G cell can schedule resources including user equipment communications based on the number of physical resource blocks each receives.

The cell-provided information can be collected as real-time statistics that are periodically (e.g., in near real time) or otherwise (e.g., on demand) reported to the radio access network (RAN) controller. The controller processes the statistics and responds with respective allocations of shared spectrum resources that are able to be used by the respective 4G-LTE and NR cells for scheduling over a number of transmission time intervals until the next reporting/allocation period is reached. In one implementation, the cell statistics for each DSS cell that shares spectrum with the other cell can include channel condition data in the form of average spectral efficiency corresponding to that cell, and traffic data in the form of total pending packet size data for that cell.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

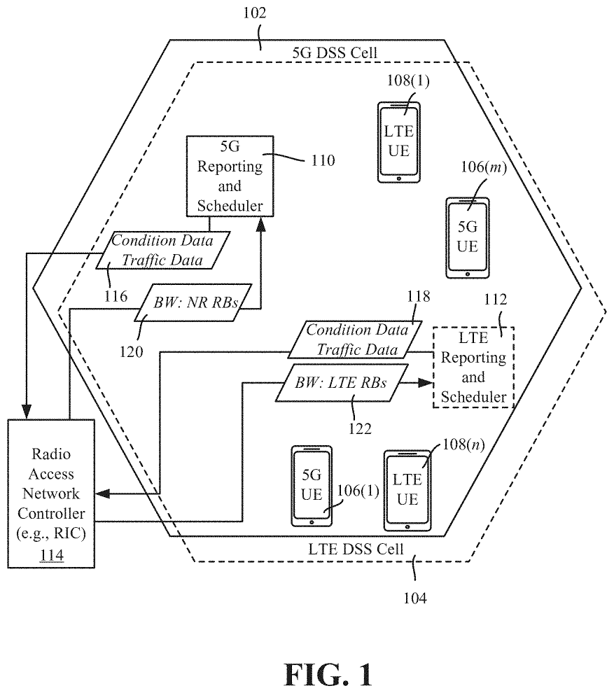

As shown in FIG. 1, a 5G cell 102 (solid line hexagonal block) and LTE cell 104 (dashed line hexagonal block) each including respective network equipment are configured for dynamic spectrum sharing as described herein. Some number 106(1)-106(m) of 5G user equipment (one or more UEs) are communicating via the network equipment of the 5G cell 102, while some number 108(1)-108(n) of LTE UEs are communicating via the network equipment of the LTE cell 104.

The network equipment of the 5G cell 102 is configured with a 5G reporting and scheduler component(s), block 110, for reporting statistics related to the 5G UEs 106(1)-106(m), and scheduling communications of the 5G UEs 106(1)-106(m) as generally described herein. The reporting and scheduler component 110 component may be implemented as separate modules or the like, but are shown in FIG. 1 as a single block for purposes of explanation. Similarly, the network equipment of the LTE cell 104 is configured with an LTE reporting and scheduler component(s), block 112, for reporting statistics related to the LTE UEs 108(1)-108(n), and scheduling communications of the LTE UEs 108(1)-108(n).

As described herein, a radio access network controller (e.g., RIC) 114 receives NR condition data and traffic data 116 from the network equipment of the 5G cell 102 and 4G-LTE condition data and traffic data 118 from the network equipment of the 4G-LTE cell 104. The radio access network controller 114 processes a combination of the received data 116 and 118 as described herein, and returns allocated bandwidth 120 (e.g., an allocation of resource blocks for 5G scheduling) to the 5G scheduler 110 and allocated bandwidth 122 (e.g., an allocation of resource blocks for LTE scheduling) to the LTE scheduler 112. As will be understood, when significant data traffic is occurring, the allocation of resource blocks can be less than the 5G scheduler 110 and/or the LTE scheduler 112 desires for use in scheduling UE communications, as each cell needs to share the total available resources.

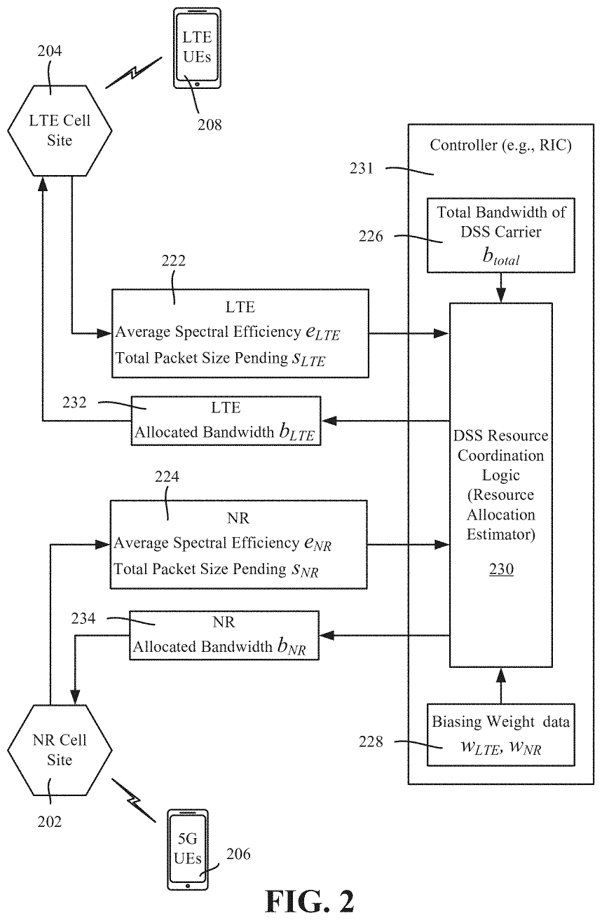

Turning to FIG. 2, additional details of one example of components and a data flow are illustrated for DSS NR and LTE cell sites 202 and 204, respectively. As is shown, the LTE cell site 204, via network equipment therein, communicates with LTE UE(s) 208, including to schedule LTE UE communications and collect information related to the LTE UE(s) 208. In FIG. 2, block 222, the LTE network condition data is represented as average spectral efficiency, e_{LTE}, and the LTE traffic data is represented by the total packet size of pending packets, s_{LTE}. For the NR cell site 202 and its connected UE(s) 206, in block 224 the NR network condition data is shown as average spectral efficiency, e_{NR}, and the NR traffic data is represented by the total packet size of pending packets, s_{NR}.

Based on the information in blocks 222 and 224, along with other information in blocks 226 and 228, DSS resource coordination logic (resource allocation estimator) 230 (such as in a controller 231) allocates LTE resource bandwidth, via block 232 to the LTE cell site 204 and NR resource bandwidth via block 234 to the NR cell site 202. In one implementation, the estimated bandwidth to each cell is returned by a number of physical resource blocks of the total available (block 226) in the shared spectrum.

More particularly, in one implementation, the NR and LTE cells 202 and 204 collect real-time cell statistics and periodically transmit the statistics (blocks 224 and 222) to the resource coordination logic 230. The statistics for each cell include, but are not limited to the average spectral efficiency e, which can be calculated based on a sliding window, and the average packet size s pending in the transmission queue from the cell's UEs, which can be calculated based on a sliding window.

With this statistical information, the resource coordination logic 230, which can be implemented in the radio access network controller (e.g., RIC) 114 of FIG. 1, estimates the resource allocation for each cell in a DSS cell pair. If the DSS cell pair are LTE and NR cells, one suitable set of formulas is:

$${b}_{LTE} = {b}_{total} * \frac{{w}_{LTE} * \frac{{s}_{LTE}}{{e}_{LTE}}}{{w}_{LTE} * \frac{{s}_{LTE}}{{e}_{LTE}} + {w}_{NR} * \frac{{s}_{NR}}{{e}_{NR}}} \\ {b}_{NR} = {b}_{total} * \frac{{w}_{NR} * \frac{{s}_{NR}}{{e}_{NR}}}{{w}_{LTE} * \frac{{s}_{LTE}}{{e}_{LTE}} + {w}_{NR} * \frac{{s}_{NR}}{{e}_{NR}}}$$

where
bₜₒₜₐₗ is the total bandwidth in resource blocks (RBs, also referred to as physical resource blocks, or PRBs) of the DSS carrier.
s_{LTE}, received from the LTE cell, is the total packet size pending in the LTE cell transmission queue from the LTE UEs.
s_{NR}, received from the NR cell, is the total packet size pending in the NR cell transmission queue from the NR UEs.
e_{LTE}, received from the LTE cell, is the average spectral efficiency of the LTE cell.
e_{NR}, received from the NR cell, is the average spectral efficiency of the NR cell.
w_{LTE} and w_{NR} are weights that can be used to bias/fine tune the resource allocation between LTE and NR cells.
b_{LTE} is the estimated bandwidth in RBs allocated for and returned to the LTE cell.
b_{NR} is the estimated bandwidth in RBs allocated for and returned to the NR cell.

It should be noted that only one of the above formulas (either for b_{LTE} or for b_{NR}) need be computed directly as shown, because if b_{LTE} is computed as the LTE resource blocks, b_{NR} is the difference from the total, that is, b_{NR}=bₜₒₜₐₗ−b_{LTE}, or if b_{NR} is computed, b_{LTE}=bₜₒₜₐₗ−b_{NR}. Any fractional computed values can be rounded as needed, as long as the total number of available resource blocks bₜₒₜₐₗ is not exceeded. It also should be noted that the resource allocation weights, the sliding window size(s) and/or the transmission periodicity can be dynamically or otherwise adjusted, e.g., by using machine learning or the like.

By way of an example, consider that NR uses the same the subcarrier spacing as LTE, e.g., 15 kilohertz, whereby one DSS carrier of 20 megahertz contains 100 PRBs in total, that is, bₜₒₜₐₗ=100 PRBs. Further, consider that at one specific reporting period, the LTE carrier has 10,000 bits pending in the transmission queue from its LTE UEs, so s_{LTE}=10,000 bits, while the NR carrier has 30,000 bits pending in the transmission queue from its NR UEs, s_{NR}=30,000 bits. In this example, the average spectral efficiency on LTE carrier, e_{LTE}=1.8 bit/Hz/s, and the average spectral efficiency on the NR carrier e_{NR}=3.6 bit/Hz/s. In this example there is no scheduling bias between the LTE cell and NR cell, so w_{LTE}=1 and w_{NR}=1.

According to the above formulas, the allocations of the 100 total PRBs are: b_{LTE}=100 (1×10000/1.8)/(1*10000/1.8+1×30000/3.6)=40 PRBs and b_{NR}=100 (1×30000/3.6)/(1*10000/1.8+1×30000/3.6)=60 PRBs.

Thus, the radio access network controller (e.g., RIC) 114 allocates and sends b_{LTE}=40 PRBs to the LTE cell, and b_{NR}=60 PRBs back to the NR cell. Accordingly when received, the LTE cell schedules no more than 40 PRBs in each of its transmission time intervals (TTIs) within the next update/reporting cycle (for example 100 milliseconds, which corresponds to 100 one-millisecond TTIs), and the NR cell schedules no more than 60 PRBs in each of its TTIs within the next update/reporting cycle.

It should be noted that FIG. 1 depicts a radio access network controller (e.g., RIC) including DSS resource coordination logic located external to the cells, such as at a remote location, whereas FIG. 2 shows a generally located controller 231, which can be a RAN Intelligent Controller (RIC), but can also be located in network equipment of one of the cells, for example, or possibly in both. Thus, the location of the logic that performs the resource allocation is described as being in a radio access network controller in general, regardless of the controller's actual location.

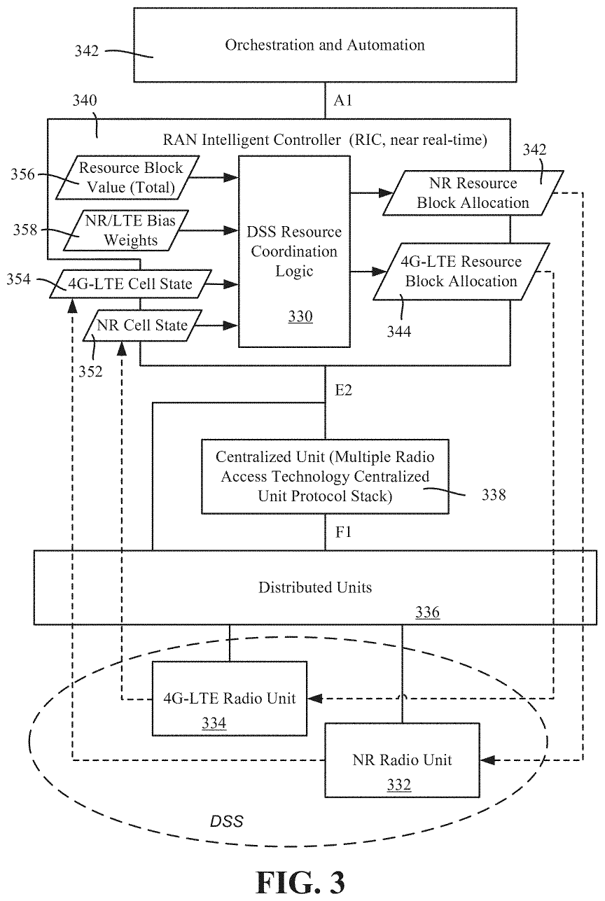

FIG. 3 shows an implementation of the technology described herein incorporated into a software platform for the RAN Intelligent Controller (RIC), which facilitates the creation of open source software that is aligned with the O-RAN target architecture. With respect to allocation of resources in a DSS environment as described herein, in general, an NR radio unit 332 corresponding to a DSS NR cell site and a 4G-LTE radio unit 334 corresponding to a DSS LTE cell site can be decoupled from distributed units 336, which in turn can be decoupled from the centralized unit 338. A RIC platform 340 is between the centralized unit/distributed units and an orchestration and automation layer 342.

In general, the RIC platform 340 provides a set of functions and interfaces (e.g., F1), including for those that facilitate DSS spectrum sharing as described herein. For example, DSS resource coordination logic 330 (corresponding to the logic 230 of FIG. 2), which can be implemented at an applications layer of the RIC platform 340, estimates the NR resource block allocation 342 and LTE resource block allocation 344 based on the statistics representing the current 4G-LTE cell state 354 and the statistics representing the current NR cell state 352, along with the total resource block value 356 and any biasing weights 358. As described herein, the NR and LTE resource block allocations are determined based on the current statistics until the next statistical reporting period.

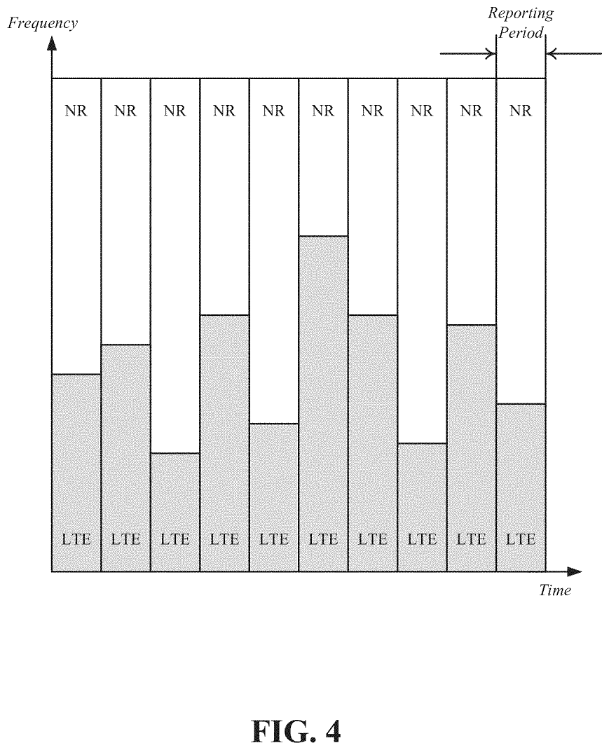

FIG. 4 shows an example of how physical resource blocks can be jointly allocated between a new radio cell site and an LTE cell site in a dynamic spectrum sharing environment. In FIG. 4, the NR physical resource blocks are shown (not individually for purposes of illustration) as unshaded blocks, while the LTE physical resource blocks are shown as shaded, per reporting period. As depicted, the total number of physical resource blocks is never exceeded, and the number allocated to each cell site for any given reporting period can vary, based on the current NR and LTE cell conditions that result in computed relative NR and LTE PRB allocations as described herein. Note that the entire carrier bandwidth (up to the physical resource blocks limit) is shown as being allocated for each reporting period in the example of FIG. 4.

To avoid collisions, in the example of FIG. 4, the LTE cell uses the allocated physical resource blocks from the lowest frequency towards the highest, while the NR cell uses the allocated physical resource blocks from the highest frequency towards the lowest. It is basically identical to do the opposite, LTE highest to lowest frequency, NR lowest to highest. In another scheme, the joint scheduler can send a bitmap or the like, (e.g., LTE uses the zeros, NR the ones, or vice versa), which facilitates interleaving LTE and NR resource block frequencies.

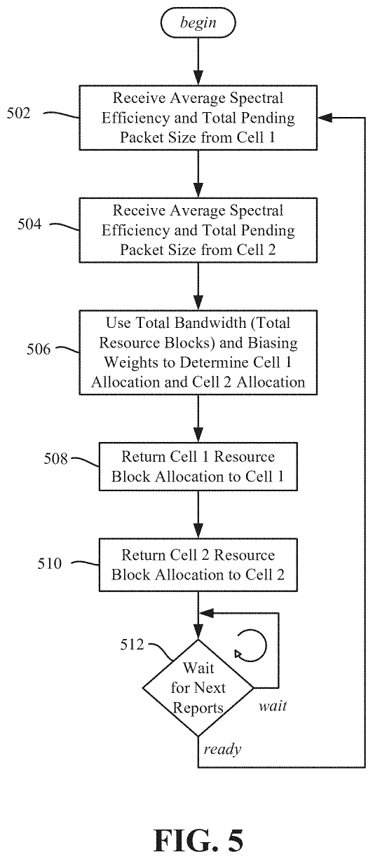

FIG. 5 is a flow diagram showing example operations of resource coordination logic (e.g., of a RIC) configured for dynamic spectrum sharing, beginning at operations 502 and 504 where two DSS cells Cell 1 and Cell 2 provide their statistics as described herein. Note that Cell 1 can be an NR cell and Cell 2 can be an LTE cell, or vice-versa, however any two dynamic spectrum sharing cells, such as 5G and a future (e.g., 6G) cell can benefit from the technology described herein, and thus two cells are described in general.

Operation 506 represents determining the cell 1 allocation (e.g., in PRBs) and cell 2 allocation (e.g., in PRBs), which as described herein can be based on the information provided via operations 502 and 504, along with the total number of resource blocks and biasing weights according to the above formula(s). As represented via operations 508 and 510, the cell 1 block allocation and cell 2 block allocation are returned to the respective cells.

As represented via operation 512, the process repeats when updated information is received. In one implementation the information is periodically reported, however other alternatives are feasible, such as on demand and so forth. However, with a near real time reporting period on the order of 100 milliseconds, any changes in LTE and NR traffic loads corresponds to relatively quick adjustments.

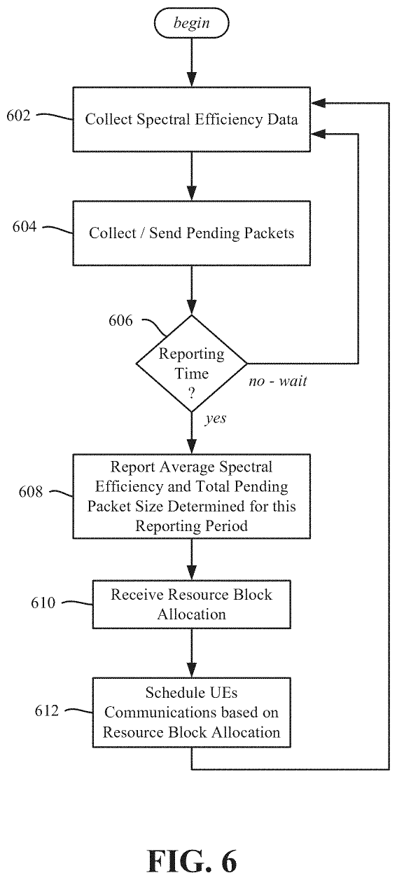

FIG. 6 shows example operations of one DSS cell's network equipment, which collects the spectral efficiency data at operation 602, and collects pending packet data (which can change as data is queued for sending and as data is sent from the transmission queue) at operation 604. At the reporting time, as represented by operation 606, operation 608 determines the average spectral efficiency and determines the current total pending packet size, and reports these data to the resource allocation logic as described herein. Based on the data reported, and the other cell of the DSS pair which performs counterpart logic to operations 602,604, 606 and 608, the resource block allocation for this cell is received at operation 610.

Operation 610 schedules the cell's connected UEs' communications based on the number of available resource blocks allocated thereto. In general, it is up to the individual cells to map their UEs to the number of physical resource blocks that were allocated for this reporting interval. This can be by priority values of the UEs, but the mapping can be based on other considerations, such as to use one or more of its allocated physical resource blocks to complete a nearly-finished UE's transmission.

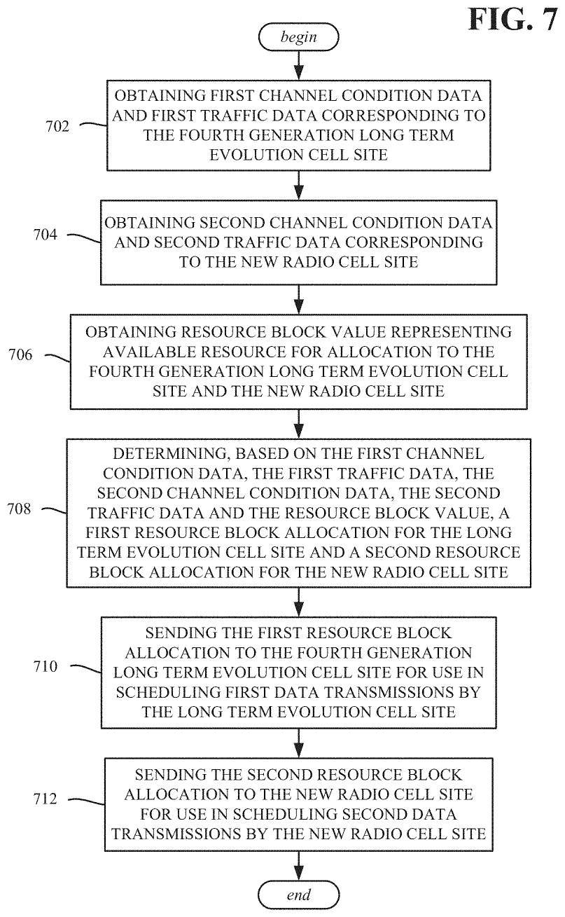

One or more example aspects are represented in FIG. 7, and can correspond to a system, comprising a processor, and a memory that stores executable instructions that, when executed by the processor of the system configured for spectrum sharing between a fourth generation long term evolution cell site and a new radio cell site, facilitate performance of operations. Example operation 702 represents obtaining first channel condition data and first traffic data corresponding to the fourth generation long term evolution cell site. Example operation 704 represents obtaining second channel condition data and second traffic data corresponding to the new radio cell site. Example operation 706 represents obtaining resource block value representing available resource for allocation to the fourth generation long term evolution cell site and the new radio cell site. Example operation 708 represents determining, based on the first channel condition data, the first traffic data, the second channel condition data, the second traffic data and the resource block value, a first resource block allocation for the long term evolution cell site and a second resource block allocation for the new radio cell site. Example operation 710 represents sending the first resource block allocation to the fourth generation long term evolution cell site for use in scheduling first data transmissions by the long term evolution cell site. Example operation 712 represents sending the second resource block allocation to the new radio cell site for use in scheduling second data transmissions by the new radio cell site.

The first channel condition data can include first spectral efficiency data and the second channel condition data includes second spectral efficiency data. The first traffic data can include first pending packet size data and the second traffic data includes second pending packet size data.

Determining the first resource block allocation for the long term evolution cell site and the second resource block allocation for the new radio cell site further can include applying weight information to bias the first resource block allocation for the long term evolution cell site relative to the second resource block allocation for the new radio cell site.

Obtaining first channel condition data and first traffic data includes receiving first spectral efficiency data and first pending packet size data from the long term evolution cell site via a periodic communication from the long term evolution cell site.

The resource block value can correspond to a total number of physical resource blocks available for allocation to the fourth generation long term evolution cell site and the new radio cell site; the first resource block allocation can correspond to a first portion of the total number from a lower frequency towards a higher frequency, and the second resource block allocation can correspond to a second portion of the total number from a higher frequency towards a lower frequency.

Sending the first resource block allocation to the fourth generation long term evolution cell site can include sending a first allocation map to the fourth generation long term evolution cell site corresponding to first ones of the first resource blocks that are allocated for use in scheduling the first data transmissions; sending the second resource block allocation to the new radio cell site can include sending a second allocation map to the new radio cell site corresponding to second ones of the second resource blocks that are allocated for use in scheduling the second data transmissions.

The processor can be incorporated into a radio access network controller.

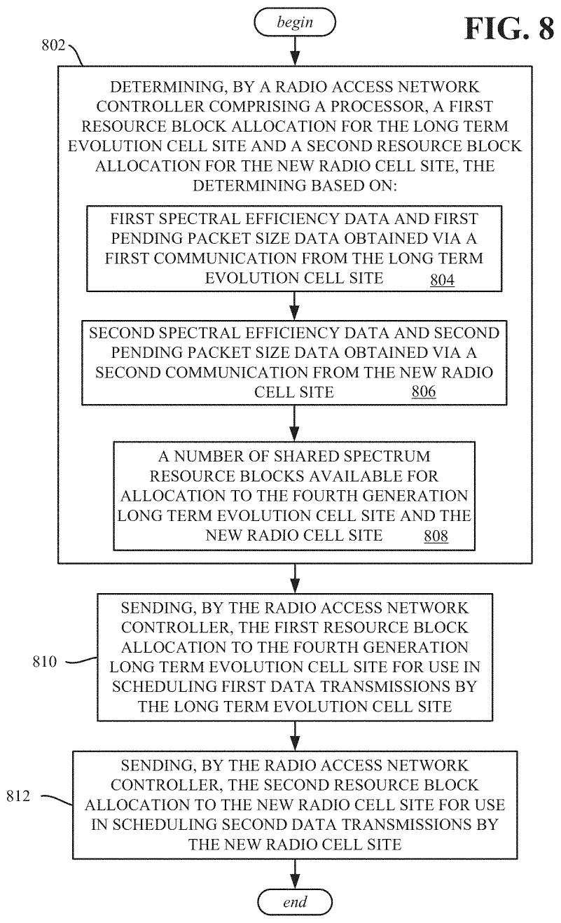

One or more example aspects are represented in FIG. 8, and can correspond to example operations of a method. Operation 802 represents determining, at a radio access network controller comprising a processor, a first resource block allocation for the long term evolution cell site and a second resource block allocation for the new radio cell site. The determining can be based on: first spectral efficiency data and first pending packet size data obtained via a first communication from the long term evolution cell site, (block 804), second spectral efficiency data and second pending packet size data obtained via a second communication from the new radio cell site (block 806), and a number of shared spectrum resource blocks available for allocation to the fourth generation long term evolution cell site and the new radio cell site (block (block 806). Operation 808 represents sending, by the radio access network controller, the first resource block allocation to the fourth generation long term evolution cell site for use in scheduling first data transmissions by the long term evolution cell site. Operation 810 represents sending, by the radio access network controller, the second resource block allocation to the new radio cell site for use in scheduling second data transmissions by the new radio cell site.

Determining the first resource block allocation for the long term evolution cell site and the second resource block allocation for the new radio cell site can include applying weight information to bias the first resource block allocation for the long term evolution cell site relative to the second resource block allocation for the new radio cell site.

Aspects can include obtaining, by the radio access network controller, updated first spectral efficiency data and updated first pending packet size data from the fourth generation long term evolution cell site, obtaining, by the radio access network controller, updated second spectral efficiency data and updated second pending packet size data from the new radio cell site, and re-determining, by the radio access network controller based on the number of available resource blocks, the updated the first spectral efficiency data, the updated first pending packet size data, the updated second spectral efficiency data and the updated second pending packet size data, an updated first resource block allocation for the long term evolution cell site and an updated second resource block allocation for the new radio cell site, sending, by the radio access network controller, the updated first resource block allocation to the fourth generation long term evolution cell site for use in scheduling first subsequent data transmissions by the long term evolution cell site, and sending, by the radio access network controller, the updated second resource block allocation to the new radio cell site for use in scheduling second subsequent data transmissions by the new radio cell site.

The first resource block allocation can correspond to a first portion of the number of the shared spectrum resource blocks from a lower frequency of the shared spectrum towards a higher frequency of the shared spectrum, and the second resource block allocation can correspond to a second portion of the number of the shared spectrum resource blocks from a higher frequency of the shared spectrum towards a lower frequency of the shared spectrum.

Sending the first resource block allocation to the fourth generation long term evolution cell site can include sending a first allocation map to the fourth generation long term evolution cell site corresponding to first ones of the first resource blocks that are allocated for use in scheduling the first data transmissions, and sending the second resource block allocation to the new radio cell site can include sending a second allocation map to the new radio cell site corresponding to second ones of the second resource blocks that are allocated for use in scheduling the second data transmissions.

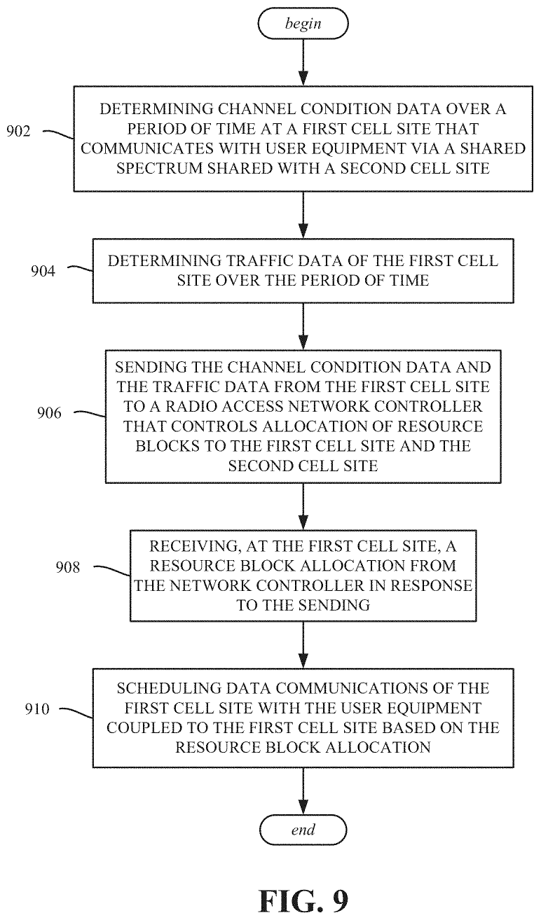

One or more aspects are represented in FIG. 9, such as implemented in a machine-readable medium, comprising executable instructions that, when executed by a processor of network equipment, facilitate performance of operations. Example operation 902 represents determining channel condition data over a period of time at a first cell site that communicates with user equipment via a shared spectrum shared with a second cell site. Example operation 904 represents determining traffic data of the first cell site over the period of time. Example operation 906 represents sending the channel condition data and the traffic data from the first cell site to a radio access network controller that controls allocation of resource blocks to the first cell site and the second cell site. Example operation 908 represents receiving, at the first cell site, a resource block allocation from the network controller in response to the sending. Example operation 910 represents scheduling data communications of the first cell site with the user equipment coupled to the first cell site based on the resource block allocation.

Determining the channel condition data can include determining average spectral efficiency data corresponding to the user equipment coupled to the first cell site.

Determining the traffic data can include determining transmission-queued packet size data corresponding to the user equipment coupled to the first cell site.

The second cell site can be a fourth generation long term evolution cell site, and sending the channel condition data and the traffic data to the radio access network controller can include transmitting the channel condition data and the traffic data from a new radio cell site.

The second cell site can be is a new radio cell site, and sending the channel condition data and the traffic data to the radio access network controller can include transmitting the channel condition data and the traffic data from a fourth generation long term evolution site.

The resource block allocation can correspond to a group of physical resource blocks from a higher frequency of the shared spectrum towards a lower frequency of the shared spectrum, and scheduling the data communications can include using the selecting physical resource blocks from the group.

The resource block allocation can correspond to a map indicating physical resource blocks of the shared spectrum assigned to the first cell site, and scheduling the data communications can include selecting physical resource blocks based on the map.

As can be seen, the technology described herein considers condition data (e.g., spectral efficiency data) and traffic data (e.g., pending packet data) to allocate bandwidth (e.g., PRBs) to LTE and NR cells that share spectrum. The technology thus helps cellular operators to smoothly migrate from current LTE to 5G NR using DSS, and improves the network and UE performance for both LTE and NR cells through the dynamic resource allocation and coordination between LTE and NR, including using a RIC, in a dynamic spectrum sharing network.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

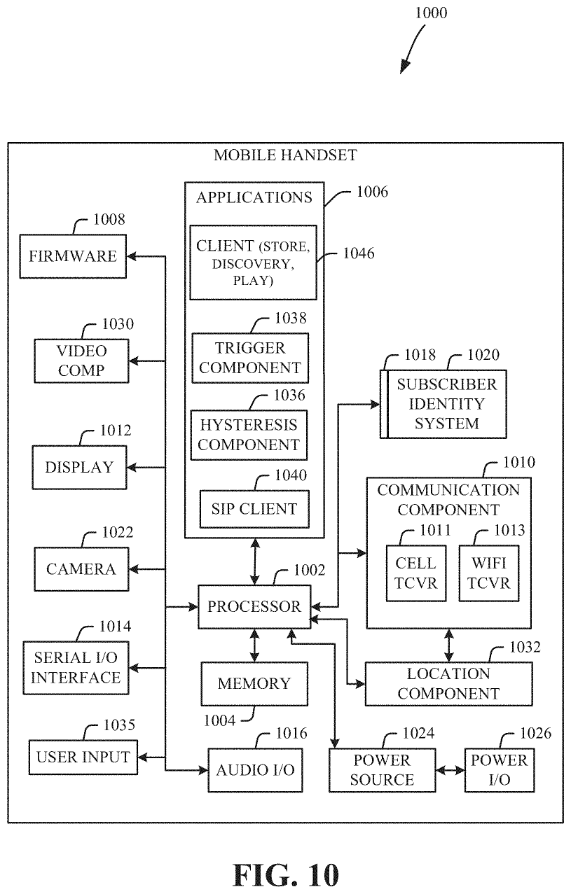

Referring now to FIG. 10, illustrated is a schematic block diagram of an example end-user device such as a user equipment) that can be a mobile device 1000 capable of connecting to a network in accordance with some embodiments described herein. Although a mobile handset 1000 is illustrated herein, it will be understood that other devices can be a mobile device, and that the mobile handset 1000 is merely illustrated to provide context for the embodiments of the various embodiments described herein. The following discussion is intended to provide a brief, general description of an example of a suitable environment 1000 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1094) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1022 (e.g., a camera) can be provided for decoding encoded multimedia content. The video processing component 1022 can aid in facilitating the generation, editing and sharing of video quotes. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 810, includes an indoor network radio transceiver 1013 (e.g., Wi-Fi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

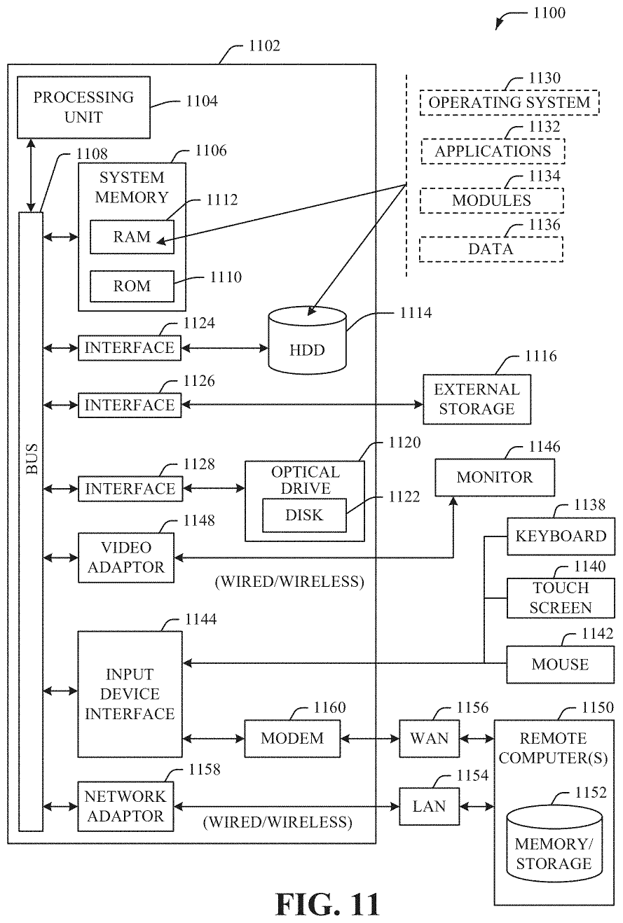

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD), non-volatile memory and other storage technology could be used in addition to, or in place of, an HDD 1114, and can be internal or external. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1094 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 11 Mbps (802.11b) or 84 Mbps (802.11a) data rate, for example, or with products that contain both bands (dual band), so the networks can provide real-world performance similar to the basic “10 BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions which, when executed by the processor of the system configured for spectrum sharing between a fourth generation long term evolution cell site and a new radio cell site, facilitate performance of operations, the operations comprising:
obtaining first channel condition data and first traffic data corresponding to the fourth generation long term evolution cell site;
obtaining second channel condition data and second traffic data corresponding to the new radio cell site;
obtaining resource block value representing available resource for allocation to the fourth generation long term evolution cell site and the new radio cell site;
determining, based on the first channel condition data, the first traffic data, the second channel condition data, the second traffic data and the resource block value, a first resource block allocation for the long term evolution cell site and a second resource block allocation for the new radio cell site;
sending the first resource block allocation to the fourth generation long term evolution cell site for use in scheduling first data transmissions by the long term evolution cell site; and
sending the second resource block allocation to the new radio cell site for use in scheduling second data transmissions by the new radio cell site.

2. The system of claim 1, wherein the first channel condition data comprises first spectral efficiency data and the second channel condition data comprises second spectral efficiency data.

3. The system of claim 1, wherein the first traffic data comprises first pending packet size data and the second traffic data comprises second pending packet size data.

4. The system of claim 1, wherein determining the first resource block allocation for the long term evolution cell site and the second resource block allocation for the new radio cell site further comprises applying weight information to bias the first resource block allocation for the long term evolution cell site relative to the second resource block allocation for the new radio cell site.

5. The system of claim 1, wherein obtaining the first channel condition data and first traffic data comprises receiving first spectral efficiency data and first pending packet size data from the long term evolution cell site via a periodic communication from the long term evolution cell site.

6. The system of claim 1, wherein the resource block value corresponds to a total number of physical resource blocks available for allocation to the fourth generation long term evolution cell site and the new radio cell site, wherein the first resource block allocation corresponds to a first portion of the total number from a lower frequency towards a higher frequency, and wherein the second resource block allocation corresponds to a second portion of the total number from a higher frequency towards a lower frequency.

7. The system of claim 1, wherein sending the first resource block allocation to the fourth generation long term evolution cell site comprises sending a first allocation map to the fourth generation long term evolution cell site corresponding to first ones of the first resource blocks that are allocated for use in scheduling the first data transmissions, and wherein sending the second resource block allocation to the new radio cell site comprises sending a second allocation map to the new radio cell site corresponding to second ones of the second resource blocks that are allocated for use in scheduling the second data transmissions.

8. The system of claim 1, wherein the processor is incorporated into a radio access network controller.

9. A method, comprising:
determining, by a radio access network controller comprising a processor, a first resource block allocation for the long term evolution cell site and a second resource block allocation for the new radio cell site, the determining based on:
first spectral efficiency data and first pending packet size data obtained via a first communication from the long term evolution cell site,
second spectral efficiency data and second pending packet size data obtained via a second communication from the new radio cell site, and
a number of shared spectrum resource blocks available for allocation to the fourth generation long term evolution cell site and the new radio cell site;
sending, by the radio access network controller, the first resource block allocation to the fourth generation long term evolution cell site for use in scheduling first data transmissions by the long term evolution cell site; and
sending, by the radio access network controller, the second resource block allocation to the new radio cell site for use in scheduling second data transmissions by the new radio cell site.

10. The method of claim 9, wherein determining the first resource block allocation for the long term evolution cell site and the second resource block allocation for the new radio cell site further comprises applying weight information to bias the first resource block allocation for the long term evolution cell site relative to the second resource block allocation for the new radio cell site.

11. The method of claim 9, further comprising obtaining, by the radio access network controller, updated first spectral efficiency data and updated first pending packet size data from the fourth generation long term evolution cell site, obtaining, by the radio access network controller, updated second spectral efficiency data and updated second pending packet size data from the new radio cell site, and re-determining, by the radio access network controller based on the number of available resource blocks, the updated the first spectral efficiency data, the updated first pending packet size data, the updated second spectral efficiency data and the updated second pending packet size data, an updated first resource block allocation for the long term evolution cell site and an updated second resource block allocation for the new radio cell site, sending, by the radio access network controller, the updated first resource block allocation to the fourth generation long term evolution cell site for use in scheduling first subsequent data transmissions by the long term evolution cell site, and sending, by the radio access network controller, the updated second resource block allocation to the new radio cell site for use in scheduling second subsequent data transmissions by the new radio cell site.

12. The method of claim 9, wherein the first resource block allocation corresponds to a first portion of the number of the shared spectrum resource blocks from a lower frequency of the shared spectrum towards a higher frequency of the shared spectrum, and wherein the second resource block allocation corresponds to a second portion of the number of the shared spectrum resource blocks from a higher frequency of the shared spectrum towards a lower frequency of the shared spectrum.

13. The method of claim 9, wherein sending the first resource block allocation to the fourth generation long term evolution cell site comprises sending a first allocation map to the fourth generation long term evolution cell site corresponding to first ones of the first resource blocks that are allocated for use in scheduling the first data transmissions, and wherein sending the second resource block allocation to the new radio cell site comprises sending a second allocation map to the new radio cell site corresponding to second ones of the second resource blocks that are allocated for use in scheduling the second data transmissions.

14. A non-transitory machine-readable medium, comprising executable instructions that, when executed by a processor of network equipment, facilitate performance of operations, the operations comprising:
determining channel condition data over a period of time at a first cell site that communicates with user equipment via a shared spectrum shared with a second cell site;
determining traffic data of the first cell site over the period of time;
sending the channel condition data and the traffic data from the first cell site to a radio access network controller that controls allocation of resource blocks to the first cell site and the second cell site;
receiving, at the first cell site, a resource block allocation from the network controller in response to the sending; and
scheduling data communications of the first cell site with the user equipment coupled to the first cell site based on the resource block allocation.

15. The non-transitory machine-readable medium of claim 14, wherein determining the channel condition data comprises determining average spectral efficiency data corresponding to the user equipment coupled to the first cell site.

16. The non-transitory machine-readable medium of claim 14, wherein determining the traffic data comprises determining transmission-queued packet size data corresponding to the user equipment coupled to the first cell site.

17. The non-transitory machine-readable medium of claim 14, wherein the second cell site is a fourth generation long term evolution cell site, and wherein sending the channel condition data and the traffic data to the radio access network controller comprises transmitting the channel condition data and the traffic data from a new radio cell site.

18. The non-transitory machine-readable medium of claim 14, wherein the second cell site is a new radio cell site, and wherein sending the channel condition data and the traffic data to the radio access network controller comprises transmitting the channel condition data and the traffic data from a fourth generation long term evolution site.

19. The non-transitory machine-readable medium of claim 14, wherein the resource block allocation corresponds to a group of physical resource blocks from a higher frequency of the shared spectrum towards a lower frequency of the shared spectrum, and wherein scheduling the data communications comprises using the selecting physical resource blocks from the group.

20. The non-transitory machine-readable medium of claim 14, wherein the resource block allocation corresponds to a map indicating physical resource blocks of the shared spectrum assigned to the first cell site, and wherein scheduling the data communications comprises selecting physical resource blocks based on the map.
